(19) United States
(12) Patent Application Publication
(10) Pub. No.: US 2006/0075144 A1
(43) Pub. Date: Apr. 6, 2006

(54) Remote access to a local hard drive

(75) Inventors: David Carroll Challener, Raleigh, NC (US); Daryl Carvis Cromer, Apex, NC (US); Howard Locker, Cary, NC (US); Randall Scott Springfield, Chapel Hill, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corp., Armonk, NY (US)

(21) Appl. No.: 10/949,550

(22) Filed: Sep. 24, 2004

(51) Int. Cl. G06F 15/16

(52) U.S. Cl. 709/250; 709/217

(57) ABSTRACT

A method and system for remotely controlling a hard drive on a local computer. A NIC includes a Port Selector under the control of a NIC processor. Access to the hard drive is selectively afforded to either the local computer or to a remote computer by the Port Selector. Preferably, the method and system permit remote access to a local hard drive even if the local computer is disabled, due to causes including, but not limited to, system failure, lost power or corrupted data on the hard drive.

### BACKGROUND OF THE INVENTION

1. Technical Field

This invention relates generally to network computing systems, and in particular to Hard Disk Drive (HDD) storage devices. Still more particularly, the present invention relates to a method and system for selectively controlling remote access to a local HDD using a port selector in a local Network Interface Card (NIC).

2. Description of the Related Art

Modern computers traditionally have a non-volatile memory, such as a Hard Disk Drive (HDD). Oftentimes, functionality of the computer depends on the HDD, particularly when booting up, accessing application files, storing data, etc. Three common reasons why a computer is unable to use a coupled HDD are 1) the HDD is infected with a virus, 2) a hardware failure has occurred, or 3) the computer has no power.

A virus is programming code that, analogous to its biological counterpart, usually infects an otherwise healthy piece of code. The virus causes an undesirable event, such as causing the infected computer to work inefficiently, or else fail completely. One such type of virus is a system infector. A system infector infects a master boot record in a hard disk. Such an infection will often make the hard drive inoperable upon a subsequent re-boot, making it impossible to boot-up the computer. Being unable to even boot-up, the computer is now unable to access the hard drive.

As noted above, a hardware failure in the computer will also prevent the computer from accessing the HDD. Such a failure may be due to anything from a defective processor to a bad memory.

Finally, as noted above, if the local computer has no power, then its HDD cannot be accessed. Such loss of power may be due to a defective power supply, a building power failure, or the power supply switch may simply be turned to the “off” position.

Typically, only a local computer can access a local HDD. Thus, if a network connected remote computer wishes to access the local computer's HDD, access must be through the local computer. Therefore, if the local computer is unable to access the HDD, then the HDD is likewise inaccessible to the network and any other computer (node) coupled to the network.

With reference now to FIG. 1, a typical prior art local computer 102 is depicted. Local computer 102 includes a core chipset 104, which typically is a Northbridge/Southbridge or similar type of chipset that affords internal data communication. Coupled to core chipset 104 is a Central Processing Unit (CPU) 106, which can perform data manipulation, including arithmetic operations, data movement and storage, etc. Also coupled to core chipset 104 is a system memory 108 for volatile storage of data, and a keyboard/mouse 110 and a display 112 for respectively inputting data and viewing computer applications.

Besides having volatile system memory 108, local computer 102 is also coupled to a non-volatile memory, depicted as a Hard Disk Drive (HDD) 114. HDD 114 is coupled to core chipset 104 via an Input/Output (I/O) bus such as a Serial Advanced Technology Attachment (SATA) bus 116.

Communication with a network 118 (such as an Ethernet or the Internet), and thus with a remote computer 120, is via a Network Interface Card (NIC) 122. NIC 122 is coupled to core chipset 104 via a second I/O bus such as a Peripheral Component Interconnect (PCI) bus 124.

As FIG. 1 illustrates, if core chipset 104 and CPU 106 or System Memory 108 are inoperable, because of a virus, power interruption, or other cause, then HDD 114 is not accessible to remote computer 120, since all communication to HDD 114 must go through core chipset 104. This lack of access becomes significant if a remote repair of HDD and/or remote recovery of data from HDD 114 is desired. For example, if HDD 114 has caused local computer 102 to crash, then HDD 114 must be physically removed and replaced with a new HDD, which must be re-imaged with an Operating System (OS), applications, data, etc. Such a process is very time consuming and, more importantly, results in a loss of user data that was stored on HDD 114.

What is needed, therefore, is a system that permits direct access to a local computer's HDD from a remote computer on a network. Preferably, such a system permits the remote computer to repair the HDD if defective and/or recover user data if the system (e.g., CPU 106, core chipset 104 and/or system memory 108) is broken.

### SUMMARY OF THE INVENTION

As will be seen, the present invention satisfies the foregoing needs and accomplishes additional objectives. Briefly described, the present invention provides a method and system for remotely controlling a hard drive on a local computer. A Network Interface Card (NIC) includes a Port Selector under the control of a NIC processor. Access to the hard drive is selectively afforded to either the local computer or to a remote computer by the Port Selector. In a preferred embodiment, the method and system permit remote access to a local hard drive even if the local computer is disabled, due to causes including, but not limited to, system failure, lost power, or corrupted data on the hard drive.

### BRIEF DESCRIPTION OF THE DRAWINGS

The novel features believed characteristic of the invention are set forth in the appended claims. The invention itself, however, as well as the preferred modes of use, further objects and advantages thereof, will best be understood by reference to the following detailed description of an illustrative embodiment when read in conjunction with the accompanying drawings, wherein:

FIG. 1 depicts a schematic diagram illustrating a prior art coupling of a hard drive to a local computer;

FIGS. 2a-b illustrate the inventive system for permitting direct access to the local computer's hard drive by a remote computer; and

FIGS. 3a-b are flow-charts of exemplary steps taken in the present invention to remotely access the local computer's hard drive.

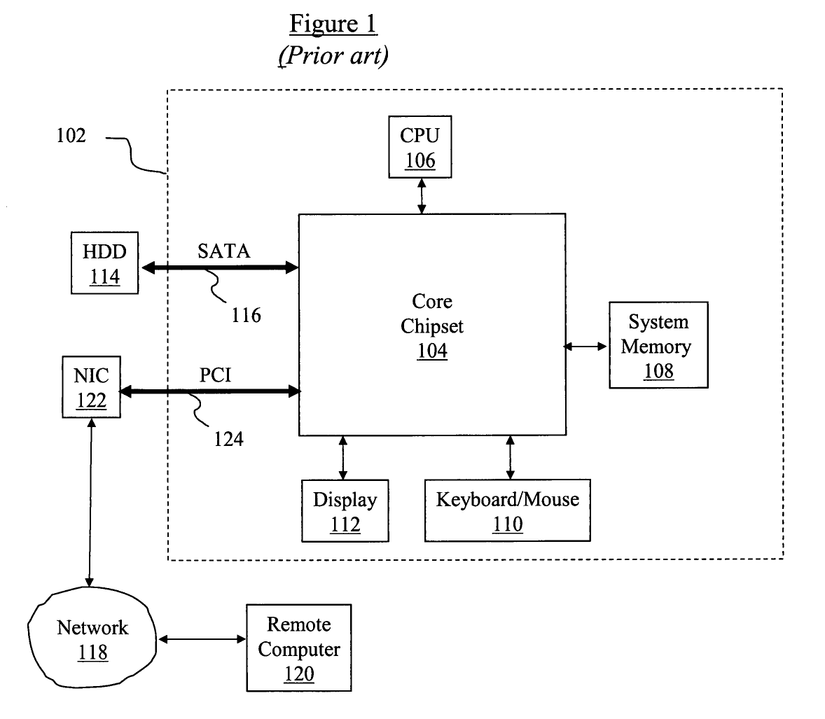

### DETAILED DESCRIPTION OF THE PREFERRED EMBODIMENT

Referring now to the drawing figures, in which like numerals indicate like elements or steps throughout the several views, a preferred embodiment of the present invention will be described. In general, the present invention provides an improved method and system for remotely accessing a local hard drive.

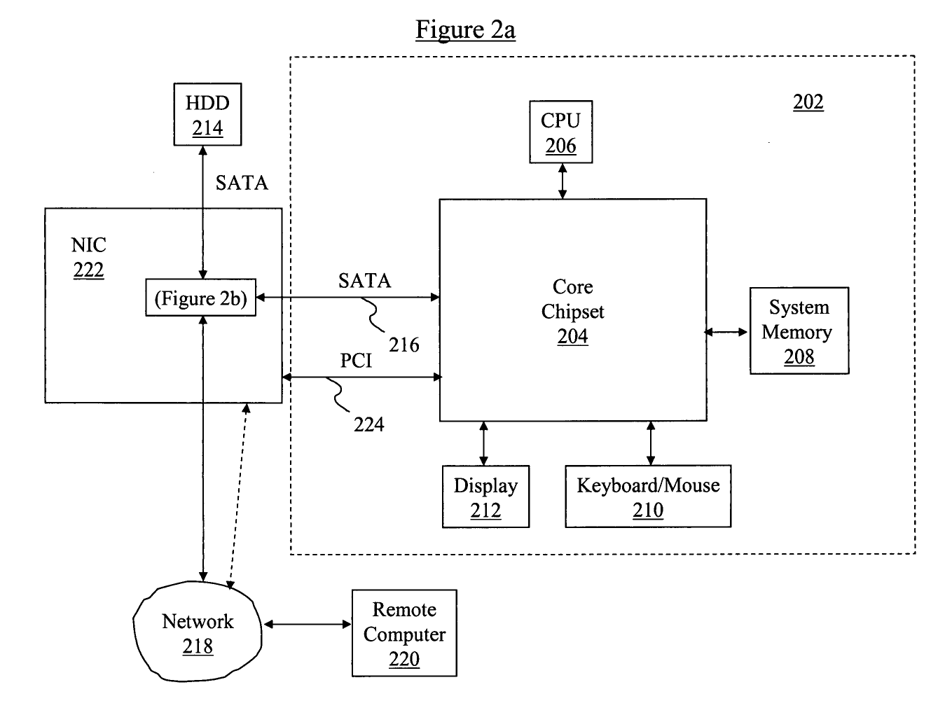

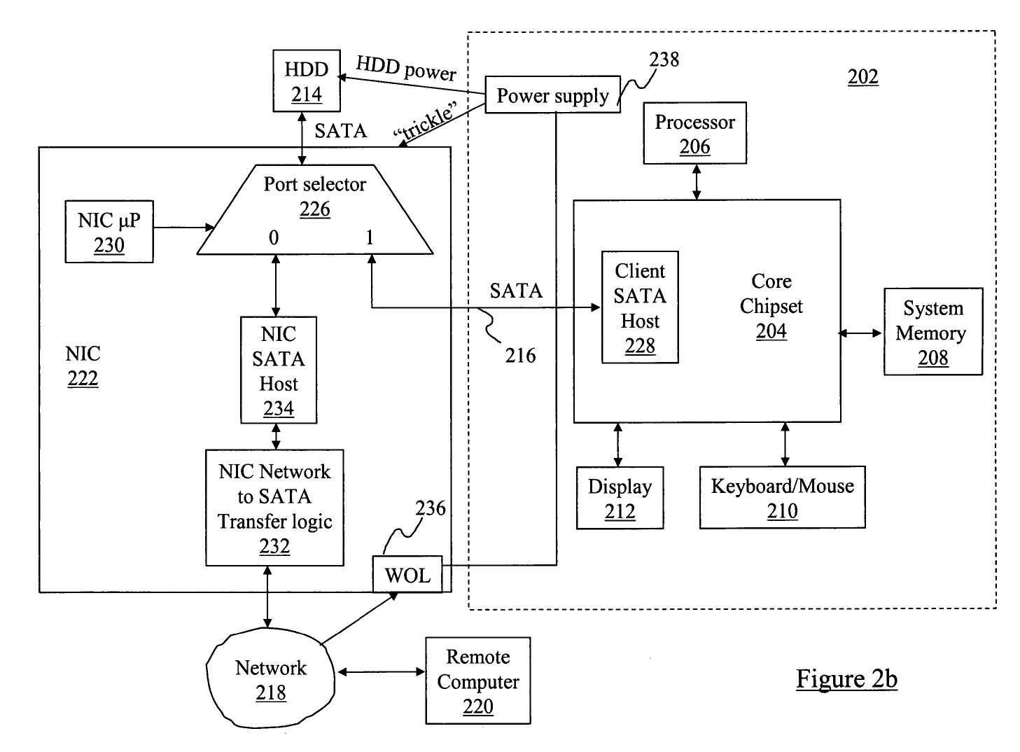

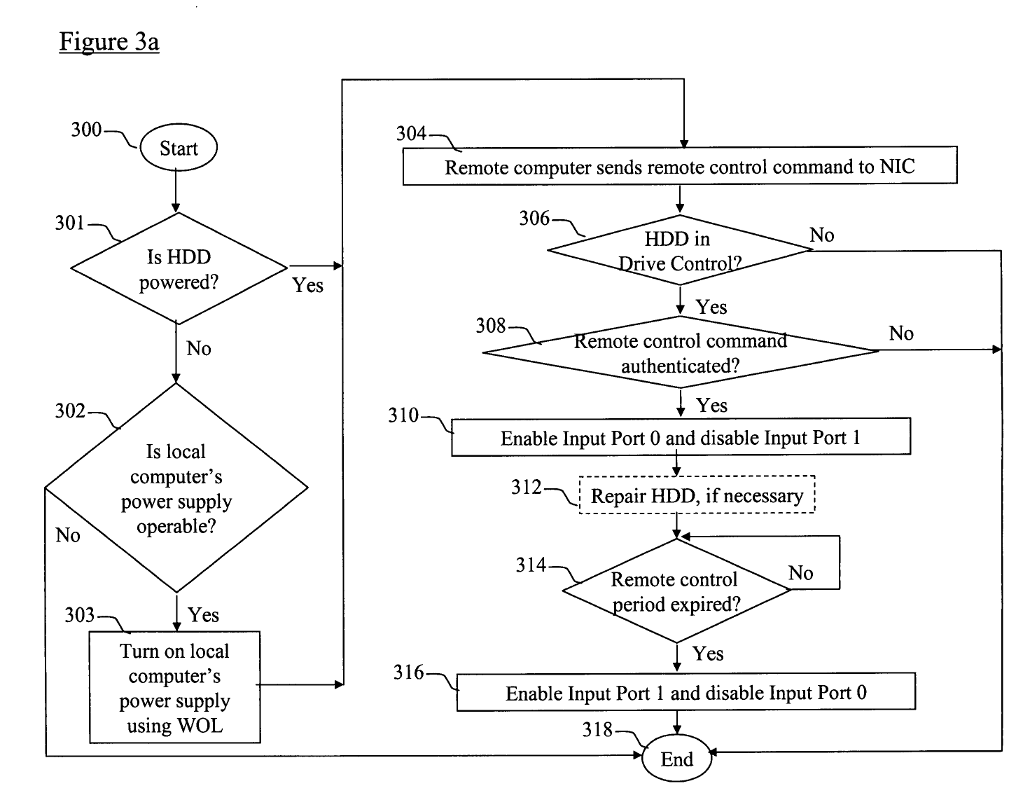

With reference now to FIG. 2a, an exemplary local computer coupled to a local hard drive is depicted. A local computer 202 includes a core chipset 204, which typically is a Northbridge/Southbridge or similar type of chipset that affords internal data communication. Coupled to core chipset 204 is a Central Processing Unit (CPU) 206, which can perform data manipulation, including arithmetic operations, data movement and storage, etc. Also coupled to core chipset 204 is a system memory 208 for volatile storage of data, and a keyboard/mouse 210 and a display 212 for respectively inputting data and viewing applications.

Besides the volatile system memory 208, local computer 202 is coupled to a non-volatile memory, depicted as a Hard Disk Drive (HDD) 214. HDD 214 is coupled to core chipset 204 via an Input/Output (I/O) bus such as a Serial Advanced Technology Attachment (SATA) bus 216, and via a port selector 226 shown in the flow control depicted in FIG. 2b.

Direct communication between a network 218 (such as an Ethernet or the Internet) and local computer 202 is through a Network Interface Card (NIC) 222 via a Peripheral Component Interconnect (PCI) bus (or PCI Express bus) 224, as shown by the dotted arrow line between NIC 222 and network 218.

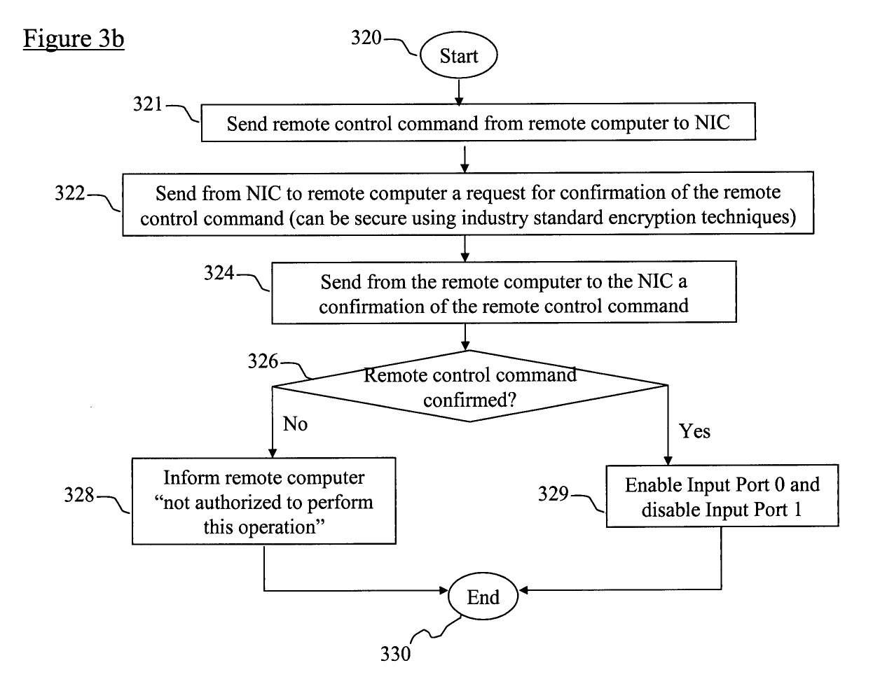

With reference to FIG. 2b, core chipset 204 includes a client SATA host 228, which permits communication between HDD 214 and core chipset 204 (and thus processor 206) via port selector 226, as described in detail in FIGS. 3a-b. NIC 222 includes a NIC processor 230 (which is preferably a microprocessor), which controls the operation of port selector 226. NIC 222 also includes a NIC network to SATA transfer logic 232, which translates packets coming from network 218, such as an Ethernet, into a SATA format understood by a NIC SATA host 234. (PCI bus 224 is not shown in FIG. 2b to avoid cluttering the figure.)

NIC 222 also includes a Wake On LAN (WOL) logic 236. If local computer 202 is turned off, a “trickle” power supply is still provided to NIC 222 from a power supply 238 in local computer 202. This trickle power allows NIC 222 and WOL logic 236 to monitor traffic from network 218 for a WOL command, such as a “magic packet” known to those skilled in the art of WOL protocols. This magic packet turns on power supply 238 to full power, allowing local computer 202 and HDD 214 to be fully powered.

Note that the exemplary embodiments shown in FIGS. 2a-b are provided solely for the purposes of explaining the invention and those skilled in the art will recognize that numerous variations are possible, both in form and function. All such variations are believed to be within the spirit and scope of the present invention.

For exemplary purposes, component reference numbers from FIG. 2b may be used in conjunction with the steps described in FIGS. 3a-b. Referring now to FIG. 3a, there is illustrated a flow-chart describing steps taken in a preferred embodiment of the present invention to remotely access a local hard drive. Proceeding from initiator step 300, a check is first made to determine if HDD 214 is powered up (query block 301). If not, then a query is made as to whether the local computer's power supply 238 is operable (query block 302). That is, if the local computer's power supply 238 is inoperable because it is unplugged from the wall outlet, or is defective, or is not Wake-On-LAN (WOL) enabled, then the process ends (terminator block 318). However, if the local computer's power supply 238 is operable and WOL enabled, then the power supply 238 is turned on (block 303), resulting in the HDD 214 being powered up. (Local computer 202 will also be powered up by the WOL command, but this is insignificant since control of HDD 214 is promptly taken over by remote computer 220, as described below.)

The remote computer 220 then sends a remote control command to the Network Interface Card (NIC) 222 (block 304). The remote control command is defined as a unique command, preferably found in a packet header, that, if valid, enables the NIC processor 230 to enable a first port “0” in port selector 226 and to contemporaneously disable a second port “1” in port selector 226, such that remote computer 220 has temporary exclusive access (above local computer 202) to HDD 214. The remote control command is initially received and processed by NIC network to SATA transfer logic 232, in which the remote control command, which is preferably received from an Ethernet (network 218), and thus is in the Ethernet protocol. Alternatively, the remote control command may come from the Internet or similar Internet Protocol (IP) based network, and thus the remote control command is in the IP protocol. No matter what type of network sent the remote control command (Ethernet, IP-based, or any other network type), the remote control command must first be translated, if necessary, into a protocol that can be understood by the HDD 214. This protocol is preferably based on the SATA protocol. The protocols and standards for SATA are described in “Serial ATA: High Speed Serialized AT Attachment, Revision 1.0a,” published 7 Jan. 2003 by the Serial ATA Workgroup, and “Serial ATA II: Extensions to Serial ATA 1.0a,” Revision 1.1, published 9 Oct. 2003 by the Serial ATA Workgroup, composed of representatives of Dell Computer Corporation, Intel Corporation, Maxtor Corporation, Seagate Technology, and Vitesse Semiconductor Corporation. These SATA publications, and their subsequent versions, are herein incorporated by reference in their entirety.

At query block 306, a query is made as to whether the HDD 214 is in “Drive Control” mode of operation. “Drive Control” is defined as a mode of operation that permits HDD 214 to directly communicate with network 218 in accordance with the present invention through the use of port selector 226 in NIC 222. If HDD 214 is not in “Drive Control,” then only the local computer 202 can ever communicate with HDD 214, and the process ends at terminator block 318.

In a preferred embodiment of the present invention, “Drive Control” is identified in a SATA Identify Device command. All SATA compliant devices issue a SATA Identify Device command during initialization. This command tells the host drive various parameters about the device, including, for hard disk drives, the number of sectors on the disks, if Direct Memory Addressing (DMA) is supported, etc. The command is made up of 255 16-bit words. Word 63 describes whether a SATA Hard Disk Drive (HDD) supports DMA. In a preferred embodiment of the present invention, Word 63 includes a new field indicating that the HDD supports “Drive Control.” Thus, the NIC processor 230 scans the SATA Identify Device command to determine if HDD 214 supports “Drive Control.” Alternatively, NIC processor 230 can directly query HDD 214 to determine if “Drive Control” is supported.

With reference now to query block 308, a query is made as to whether the remote control command is authentic. In a preferred embodiment, a portion or all of the remote control command is encrypted, preferably using Hashed Message Authentication Codes (HMAC), as described in “HMAC: Keyed-Hashing for Message Authentication,” published by the Network Working Group as Request for Comments (RFC) 2104 in February 1997, which is herein incorporated by reference in its entirety. HMAC uses a hash function (H), which uses a secret key (K). In a preferred embodiment of the present invention, the secret key K is a number known to both remote computer 220 and NIC processor 230.

To prevent replay and the further ensure authenticity of the remote control command, a system may be used such as KryptoKnight, developed by International Business Machines (IBM) and described by R. Bird, et al. in “The KryptoKnight Family of Light-Weight Protocols for Authentication and Key Distribution,” IEEE/ACM Transactions on Networking, vol. 3, no. 1, pp. 31-41, 1995, which is herein incorporated by reference in its entirety. Using a randomly generated one-time key called a Machine Authentication Code (MAC), replay can be prevented using the procedure described in FIG. 3b.

After initiator block 320, a remote computer 220 sends a remote control command to NIC 222 (block 321), as described above for block 304. Next, as shown in block 322 of FIG. 3b, a request for confirmation of the remote command is sent from NIC 222 to remote computer 220. Included in this request for confirmation is a randomly generated single-use number, which is preferably hashed and/or encrypted in the request for confirmation command. As shown in block 324, the remote computer 220 then sends the NIC 222 the requested confirmation message, which includes the randomly generated single-use number sent by the NIC 222 to the remote computer 220. The NIC 222, and specifically NIC processor 230, then confirms that the confirmation came from the authorized remote computer 220, and that the message contains the same randomly generated single-use number (query block 326). If the confirmation is invalid (block 328), then access to the HDD 214 is denied to the remote computer 220, which is so notified, and the process ends (terminator block 330). If confirmation is valid, however, then access to HDD 214 is allowed to remote computer 220 (block 329), as described below in block 310.

With reference again to FIG. 3a, as described in block 310, if the remote control command is authenticated, then NIC processor 230 enables Input Port 0 while concurrently disabling Input Port 1. This permits communication between remote computer 220 and HDD 214, while preventing contemporaneous communication between local computer 202 and HDD 214.

Access to and control of HDD 214 by remote computer 220 is usually a temporary matter. That is, remote computer 220 preferably does not want to permanently commandeer HDD 214, but rather desires only temporary control of HDD 214, in order to install, if necessary, a corrective patch, re-image a disk, etc. (block 312), which will ultimately allow remote computer 220 to again function properly using HDD 214. A query is made (query block 314) as to whether the remote control period has expired. This period may be temporal (set by a pre-determined length of time) or may be activity-based (set by a pre-determined number of packets, commands, bits, bytes, etc. received from remote computer 220).

If the remote control period has expired, then second Input Port 1 is re-enabled and first Input Port 0 is disabled (block 316), thus allowing NIC processor 230 to enable exclusive access to HDD 214 to local computer 202. By controlling the first and second ports of port selector 226, NIC processor 230 enables alternative access to HDD 214 by both local computer 202 and remote computer 220.

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media, or USB storage devices), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention. For example, while the local hard drive described in the present invention has been illustrated as a HDD 214, this local hard drive may alternatively be any non-volatile storage device, including a Compact Disk—Read Only Memory (CD-ROM) drive, a Digital Versatile Disk (DVD) drive, etc.

What is claimed is:

1. A system comprising:
a Central Processing Unit (CPU);
a Network Interface Card (NIC) including:
a NIC processor,
a port selector under the control of the NIC processor, the port selector having:
a first input port,
a second input port, and
an output port coupled to a hard drive, and
an interface to a network; and
a core chipset logically coupling the CPU to the NIC, the core chipset including a client input/output (I/O) bus host, wherein the network interface is coupled to the first input port and the client I/O bus host is coupled to the second input port, such that the NIC processor is capable of selectively logically coupling the hard drive exclusively to either the network or the processor via the port selector.

2. The system of claim 1, wherein the NIC further comprises:
a NIC Serial Advanced Technology Attachment (SATA) host coupled to the port selector; and
a NIC network to SATA transfer logic coupling the NIC SATA host to the network, wherein a data packet from the network is converted into a SATA format before being selectively sent to the hard drive via the NIC SATA host and the port selector.

3. The system of claim 2, wherein the client I/O bus host is a client SATA host that is SATA compliant.

4. The system of claim 3, wherein the hard drive is pre-programmed with a Drive Control mode of operation, wherein the hard drive can receive data over an SATA bus from either the client SATA host or the NIC SATA host.

5. The system of claim 4, wherein the hard drive is capable of Direct Memory Access (DMA) from either the client SATA host or the NIC SATA host.

6. The system of claim 1, wherein the NIC processor is capable of receiving a remote control command from a remote computer, the remote control command instructing the NIC processor to disable the second input port and enable the first input port, wherein data communication with the hard drive is exclusively with the remote computer.

7. The system of claim 6, wherein after a pre-determined period of time from when the remote control command was received by the NIC processor, the first input port is disabled and the second input port is enabled to re-establish exclusive data communication between the hard drive and the client SATA host.

8. The system of claim 6, wherein after a pre-determined number of data packets have been received by the NIC SATA host from the remote computer, the first input port is disabled and the second input port is enabled to re-establish exclusive data communication between the hard drive and the client SATA host.

9. The system of claim 6, wherein the NIC further comprises a Wake-On-LAN (WOL) logic capable of receiving a remote signal to turn on a power supply.

10. A method comprising:
coupling a local computer to a Network Interface Card (NIC);
coupling a port selector in the NIC to a hard drive, the port selector having:
a first input port coupled to a network,
a second input port coupled to a local client computer, and
an output port coupled to the hard drive;
receiving a remote control command at a Network Interface Card (NIC) processor from a remote computer coupled to the network; and
in response to determining that the remote control command is valid, enabling the first input port and disabling the second input port, wherein the remote computer has exclusive access to the hard drive.

11. The method of claim 10, wherein the port selector is controlled by a NIC processor located in the NIC.

12. The method of claim 11, further comprising disabling the first input port and enabling the second input port after a pre-determined period of time from when the NIC processor received the remote control command.

13. The method of claim 1 1, further comprising disabling the first input port and enabling the second input port after the NIC processor has received a pre-determined number of data packets from the remote computer.

14. The method of claim 11, further comprising:
sending, from the NIC to the client computer, a request for an authentication of the remote control command, the request for the authentication including a randomly generated number.

15. The method of claim 12, further comprising sending the requested authentication, the authentication including the randomly generated number sent in the request for the authentication to prevent a replay of the remote control command.

16. The method of claim 13, wherein the remote control command is encrypted in accordance with a Hashed Message Authentication Code (HMAC).

17. The method of claim 11, further comprising repairing the hard drive using software sent from the remote computer to the hard drive.

18. The method of claim 11, wherein the NIC is able to function independently of the local computer, such that the remote computer can communicate data packets to the hard drive even when the local computer is disabled.

19. A computer program product, residing on a computer usable medium, the computer program product comprising:
program code for coupling a local computer to a Network Interface Card (NIC);
program code for coupling a port selector in the NIC to a hard drive, the port selector having:
a first input port coupled to a network,
a second input port coupled to a local client computer, and
an output port coupled to the hard drive;
program code for receiving a remote control command at a Network Interface Card (NIC) processor from a remote computer coupled to the network; and
program code for, in response to determining that the remote control command is valid, enabling the first input port and disabling the second input port, wherein the remote computer has exclusive access to the hard drive.

20. The computer program product of claim 18, wherein the NIC is able to function independently of the local computer, such that the remote computer can communicate data packets to the hard drive even when the local computer is disabled.
